(19) United States
(12) Patent Application Publication
(10) Pub. No.: US 2026/0064176 A1
(43) Pub. Date: Mar. 5, 2026

(54) ELECTRICAL POWER CONTROL DEVICES AND RELATED METHODS

(71) Applicant: ABB SCHWEIZ AG, Baden (CH)

(72) Inventors: Huangjie Gong, Raleigh, NC (US); Matthew Hetrich, Cary, NC (US); Abhinav Patni, Raleigh, NC (US); Sheng Zhong, Hillsborough, NC (US)

(21) Appl. No.: 18/824,872

(22) Filed: Sep. 4, 2024

(51) Int. Cl. G06F 1/26; B60L 53/62; G06Q 50/06

(52) U.S. Cl. CPC G06F 1/266; B60L 53/62; G06Q 50/06

(57) ABSTRACT

Electrical power control devices may include a main power connection for transmitting electrical power to a disconnect panel, an auxiliary power connection for transmitting electrical power to an auxiliary device, and an auxiliary control module. The auxiliary control module may include at least one sensor for sensing a total current flowing through the main power connection and the auxiliary power connection and a control server configured to send instructions to the auxiliary device to control power usage based on a comparison of the total current to a predetermined threshold. Various other related systems and methods may employ such electrical power control devices.

### BACKGROUND

The increasing popularity of electric vehicles (EVs) and other auxiliary electrical devices has led to a rise in energy use in homes. This higher energy usage, including from homes with EV chargers, can benefit from electrical power data monitoring. Such monitoring systems may be helpful in comprehending energy use patterns and improving overall consumption. The data obtained can offer homeowners useful details about their energy use, allowing them to better control power and balance between everyday electricity needs and auxiliary demands (EV charging demands). Higher energy bills can often result from increased electrical loads, making power data monitoring a helpful consideration for homeowners who have auxiliary electrical needs. These monitoring systems can also support utility companies in handling grid load more efficiently, helping avoid power outages or fluctuations that could disrupt service.

### SUMMARY

In some aspects, the techniques described herein relate to an electrical power control device, including: a main power connection for transmitting electrical power to a disconnect panel; an auxiliary power connection for transmitting electrical power to an auxiliary device; and an auxiliary control module, including: at least one sensor for sensing a total current flowing through the main power connection and the auxiliary power connection; and a control server configured to send instructions to the auxiliary device to control power usage based on a comparison of the total current to a predetermined threshold.

In some aspects, the techniques described herein relate to a device, further including a communication module for communicating information based on the total current to a user device.

In some aspects, the techniques described herein relate to a device, wherein the communication module includes an antenna for wirelessly communicating the information to the user device.

In some aspects, the techniques described herein relate to a device, wherein the communication module includes a wired connection for communicating the information to the user device.

In some aspects, the techniques described herein relate to a device, wherein the at least one sensor includes at least one of: an input sensor for sensing an electrical current in an input power connection leading to the main power connection and the auxiliary power connection; or a main current sensor for sensing an electrical current in the main power connection and an auxiliary current sensor for sensing an electrical current in the auxiliary power connection.

In some aspects, the techniques described herein relate to a device, wherein the auxiliary device includes at least one of: an electric vehicle charging station, or an electric vehicle.

In some aspects, the techniques described herein relate to a device, wherein the control server is configured to send instructions to the electric vehicle charging station or the electric vehicle using an Open Charge Point Protocol (OCPP) communication standard.

In some aspects, the techniques described herein relate to a device, wherein the control server is further configured to send instructions to the auxiliary device to control power usage based on user preferences.

In some aspects, the techniques described herein relate to a device, wherein the user preferences include at least one of: a user-defined maximum current limit; or user-defined preferred time-of-day charging indications.

In some aspects, the techniques described herein relate to a device, wherein the control server is further configured to send instructions to the auxiliary device to control power usage based on local electricity generation data.

In some aspects, the techniques described herein relate to a device, wherein the predetermined threshold increases when local electricity generation increases.

In some aspects, the techniques described herein relate to a device, wherein the control server is further configured to send instructions to the auxiliary device to control power usage in response to an external control signal communicated to the control server.

In some aspects, the techniques described herein relate to a device, further including an auxiliary disconnect along the auxiliary power connection.

In some aspects, the techniques described herein relate to a device, wherein the disconnect panel includes a breaker panel.

In some aspects, the techniques described herein relate to an electrical power control device, including: a main power connection for transmitting electrical power to a disconnect panel; an auxiliary power connection for transmitting electrical power to at least one of: an electric vehicle (EV) charging station or an EV; and an auxiliary control module, including: at least one sensor for sensing a total current flowing through the main power connection and the auxiliary power connection; and a control server configured to send instructions to the EV charging station or EV to control power usage of the EV charging station or EV based on a comparison of a total current to a predetermined threshold.

In some aspects, the techniques described herein relate to a device, wherein the control server is configured to send instructions to the EV charging station or EV using an Open Charge Point Protocol (OCPP) communication standard.

In some aspects, the techniques described herein relate to a device, wherein the main power connection and the auxiliary power connection receive electrical power from a power meter.

In some aspects, the techniques described herein relate to a device, wherein the control server is configured to send instructions to the EV charging station or EV to reduce power usage when the total current reaches or exceeds the predetermined threshold and to increase power usage when the total current drops below the predetermined threshold.

In some aspects, the techniques described herein relate to a method of forming an electrical power control device, the method including: coupling at least one main sensor to a main power connection to sense at least one first electrical characteristic of the main power connection and to generate main sensor data; coupling at least one auxiliary sensor to an auxiliary power connection to sense at least one second electrical characteristic of the auxiliary power connection and to generate auxiliary sensor data; and coupling the at least one main sensor and the at least one auxiliary sensor to an auxiliary control module configured to send a control instruction to an auxiliary device, such that the main sensor data and the auxiliary sensor data can be provided to the auxiliary control module.

In some aspects, the techniques described herein relate to a method, wherein: coupling the at least one main sensor to the main power connection includes coupling a main current sensor to the main power connection; and coupling the at least one auxiliary sensor to the auxiliary power connection includes coupling an auxiliary current sensor to the auxiliary power connection.

### BRIEF DESCRIPTION OF THE DRAWINGS

FIG. 1 is a schematic diagram of a power supply system that includes an electrical power control device, according to at least one embodiment of the present disclosure.

FIG. 2 is a schematic diagram of a power supply system that includes an electrical power control device, according to at least one additional embodiment of the present disclosure.

FIG. 3 is a schematic diagram of a power supply system that includes an electrical power control device, according to at least one further embodiment of the present disclosure.

FIG. 4 is a schematic diagram of an electrical power control device, according to at least one embodiment of the present disclosure.

FIG. 5 is a plot illustrating an example of power usage of a power supply system over the course of a day, according to at least one embodiment of the present disclosure.

FIG. 6 is a flow diagram illustrating a method of operating an electrical power control device, according to at least one embodiment of the present disclosure.

FIG. 7 is a flow diagram illustrating a method of forming an electrical power control device, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure provides detailed descriptions of power supply systems that include electrical power control devices. As will be explained in greater detail below, embodiments of the present disclosure may include electrical power control devices that include a main power connection for transmitting electrical power to a disconnect panel and an auxiliary power connection for transmitting electrical power to an auxiliary device. The electrical power control devices may also include an auxiliary control module that includes at least one sensor for sensing a total current flowing through the main power connection and the auxiliary power connection and a control server configured to send instructions to the auxiliary device to control power usage based on a comparison of the total current to a predetermined threshold. Such devices may be capable of monitoring and controlling electrical energy use, such as to limit the energy use to the predetermined threshold.

Features from any of the embodiments described herein may be used in combination with one another in accordance with the general principles described herein. These and other embodiments, features, and advantages will be more fully understood upon reading the following detailed description in conjunction with the accompanying drawings and claims.

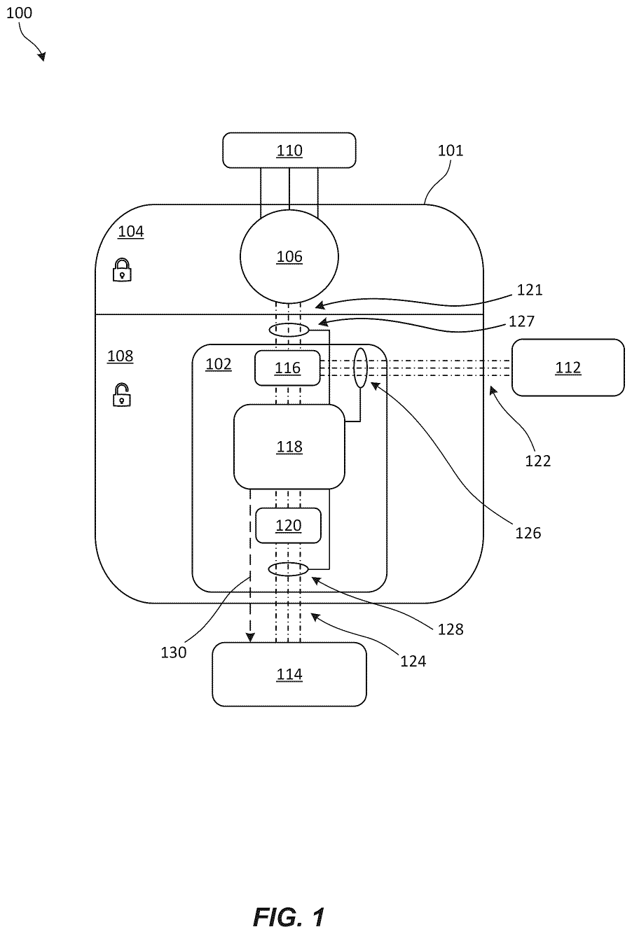

FIG. 1 is a schematic view of a power supply system 100 that includes an electrical power control device 102, according to at least one embodiment of the present disclosure. The power supply system 100 may be in the form of an expanded meter socket 101 that includes the electrical power control device 102.

For example, the power supply system 100 may include a meter socket section 104 that houses a power meter 106 and a power monitoring section 108 that houses the electrical power control device 102. In some embodiments, the meter socket section 104 may be locked or otherwise access-limited (e.g., for access only by personnel authorized by a power company), such as to inhibit tampering and/or theft of electrical power and for safety. The power monitoring section 108 may be accessible by a user and/or electrician (e.g., without authorization by a power company), such as for installation, maintenance, modification, etc.

The power supply system 100 may be connected at an input side to a utility grid 110 for providing power to the power supply system 100, through the electrical power control device 102, and ultimately to a user's electrical systems, such as to a disconnect panel 112 (e.g., a residential breaker panel, a commercial breaker panel, a fuse box, a fusible switch box, a protective relay panel, etc.) and/or to an auxiliary device 114. In the example shown in FIG. 1, the utility grid 110 may provide a single phase (e.g., three-wire) alternating current (AC) power supply including at least a hot wire and a neutral wire. In additional examples, the utility grid 110 may be a two-wire AC power supply or a four-wire AC power supply. The AC power supply from the utility grid 110 may be a single-phase (e.g., split-phase) AC power supply or a three-phase AC power supply.

Power from the utility grid 110 may pass through the power meter 106 for measuring total electrical power usage through the disconnect panel 112 and the auxiliary device 114. An output side of the power meter 106 may be operably connected to a power input of the electrical power control device 102, such as via suitable conductors (e.g., cables, wires, traces, etc.).

The electrical power control device 102 may include an input disconnect 116, an auxiliary control module 118, and an auxiliary disconnect 120. An input power connection 121 may be capable of transmitting electrical power from the meter socket section 104, and ultimately from the utility grid 110, to the power monitoring section 108 and to the electrical power control device 102. A main power connection 122 of the electrical power control device 102 may be capable of transmitting electrical power from the electrical power control device 102 to the disconnect panel 112. An auxiliary power connection 124 of the electrical power control device 102 may be capable of transmitting electrical power from the electrical power control device 102 to and/or from the auxiliary device 114.

The input disconnect 116 may be positioned between the power meter 106 and the auxiliary control module 118 and between the power meter 106 and the disconnect panel 112. In some embodiments, the input disconnect 116 may be rated with a sufficiently high amperage to supply full power to both the disconnect panel 112 and the auxiliary device 114. In other words, the current rating of the input disconnect 116 may be the same as a current rating of the disconnect panel 112 or at least as high as the combination of the disconnect panel 112 rating and of the auxiliary device 114 rating, such as to reduce instances of the input disconnect 116 inadvertently opening and halting service to both the disconnect panel 112 and to the auxiliary device 114.

The auxiliary disconnect 120 may be positioned between the auxiliary control module 118 and the auxiliary device 114. The auxiliary disconnect 120 may be configured to interrupt service to or from the auxiliary device 114 for installation or maintenance, in case of a fault (e.g., short-circuit) in the auxiliary device 114, for installation or maintenance of the auxiliary control module 118, etc.

As will be explained further below, the auxiliary control module 118 may be configured to sense a total electrical characteristic (e.g., current and/or voltage) of the input power connection 121, at least one first electrical characteristic (e.g., current and/or voltage) of the main power connection 122, and/or at least one second electrical characteristic (e.g., current and/or voltage) of the auxiliary power connection 124. For example, the electrical power control device 102 may include an input sensor 127 for sensing the total electrical characteristic of the input power connection 121, at least one main sensor 126 for sensing the first electrical characteristic of the main power connection 122, and at least one auxiliary sensor 128 for sensing the second electrical characteristic of the auxiliary power connection 124. In some cases, the input sensor 127 may be positioned in front of the main disconnect 116 for sensing the total current flow to the disconnect panel 112 and to the auxiliary device 114. By way of example and not limitation, each of the input sensor 127, at least one main sensor 126, and at least one auxiliary sensor 128 may be in the form of an inductive sensor, a current shunt sensor, a Hall effect-based sensor, a fluxgate sensor, and/or a Rogowski principle-based sensor (e.g., a Rogowski coil sensor).

In some examples, the input sensor 127 may be present to sense a total current in the input power connection, and the main sensor 126 and auxiliary sensor 128 may be absent. In other examples, the main sensor 126 and auxiliary sensor 128 may be present and in combination may sense a total current flowing through the system. In this case, the input sensor 127 may be absent. In additional examples, all of the input sensor 127, main sensor 126, and auxiliary sensor 128 may be present.

The auxiliary control module 118 may be in the form of a printed circuit board (PCB) that includes at least an analog-to-digital converter for processing signals from the input sensor 127, at least one main sensor 126, and at least one auxiliary sensor 128 and a control server configured to send instructions 130 to the auxiliary device 114 to control (e.g., reduce, increase, maintain, etc.) power usage based on a comparison of a total current to a predetermined threshold. For example, the total current may be measured at the input sensor 127, or measurements from the at least one main sensor 126 and from the at least one auxiliary sensor 128 may be added together to determine the total current. For example, the instructions 130 may cause the auxiliary device 114 to reduce electricity usage when the total current reaches or exceeds the predetermined threshold and to increase electricity usage when the total current drops below the predetermined threshold.

The control server may also be configured to send the instructions 130 to control power usage of the auxiliary device 114 based on user preferences, such as a user-defined maximum current limit and/or user-defined preferred time-of-day charging indications. For example, a user may indicate to the auxiliary control module 118 that electricity cost is higher during certain times of the day. During those times, the auxiliary control module 118 may reduce power consumption by enforcing a lower current limit, such as by causing the control server to send the instructions 130 to the auxiliary device 114 to operate at a lower current. During times of low electricity cost, the instructions 130 may cause the auxiliary device 114 to operate at a higher current.

In additional examples, the control server may be configured to send the instructions 130 to the auxiliary device 114 based on local electricity generation data. For example, if the power supply system 100 is connected to a local electricity generation device (e.g., a solar panel, a wind turbine, etc.), the instructions 130 may cause the auxiliary device 114 to draw more electricity during times of local electricity generation or relatively high local electricity generation. Conversely, the instructions 130 may cause the auxiliary device 114 to draw less electricity during times of relatively low or no local electricity generation.

In examples where the auxiliary device 114 is an EV charging station or an EV, the control server may be configured to send the instructions 130 to the auxiliary device 114 using an Open Charge Point Protocol (OCPP) communication standard set by the Open Charge Alliance (OCA) organization. The OCPP communication standard is a uniform language used by many EV charging station vendors and EV suppliers for communications with EV charging stations and EVs. In embodiments in which an OCPP communication standard is used by the control server to send the instructions 130, any EV charging station or EV that can communicate via OCPP may be used as the auxiliary device 114, regardless of manufacturer or type of the EV charging station or EV.

In additional embodiments in which the auxiliary device 114 is an EV charging station or EV that does not use OCPP or is not an EV charging station or EV, the control server may send the instructions 130 in any other suitable manner. For example, the control server may identify the type and/or model of the auxiliary device 114 and may use a lookup table, database, or the like to send the instructions 130 in a format that the auxiliary device 114 may accept.

In some examples, the auxiliary control module 118 may also include a communication module for communicating information based on the total current to a user device or other recipient and/or for receiving information or commands from the user device. The communication module, if present, may communicate with the user device or other recipient via a wireless connection (e.g., an antenna) and/or via a wired connection.

One or more of the components of the auxiliary control module 118 may be implemented via one or more microprocessors, signal processing components, transistors, transceivers, etc.

In some examples, relational terms, such as “first,” “second,” etc., may be used for clarity and convenience in understanding the disclosure and accompanying drawings and do not connote or depend on any specific preference, orientation, or order, except where the context clearly indicates otherwise.

In some embodiments, the first electrical characteristic and the second electrical characteristic may include current and/or voltage, and/or a characteristic derived from current and/or voltage (e.g., power). The auxiliary control module 118 may be configured to communicate the first and second electrical characteristic, or information based on the first and second electrical characteristic, to a user device or other recipient. For example, the input sensor 127 may be or include an input current sensor for sensing an electrical current in the input power connection 121. Likewise, the main sensor 126 may be or include a first current sensor for sensing an electrical current in the main power connection 122 and the auxiliary sensor 128 may be or include a second current sensor for sensing an electrical current in the auxiliary power connection 124.

The auxiliary device 114 may be one or more devices that use electrical power. Examples of the auxiliary device 114 include an electric vehicle (EV) charging station, an EV, a pump, an air conditioning unit, a heater, a refrigerator. Other devices that draw electrical power may also be considered auxiliary devices 114. In additional embodiments of the present disclosure, the auxiliary device 114 may generate electricity, and the auxiliary power connection 124 may operate as an input, such as for providing electrical power to the disconnect panel 112. For example, the auxiliary device 114 may be or include a wind turbine, a water turbine, a thermal power generator, a gas generator, a solar panel, etc. Accordingly, the at least one auxiliary sensor 128 can, in some embodiments, be used to obtain power data regardless of the direction that electrical current flows in the auxiliary power connection 124.

FIG. 1 illustrates a single auxiliary device 114. However, the present disclosure is not so limited. In additional examples, the auxiliary device 114 may represent multiple auxiliary devices 114 connected to the electrical power control device 102.

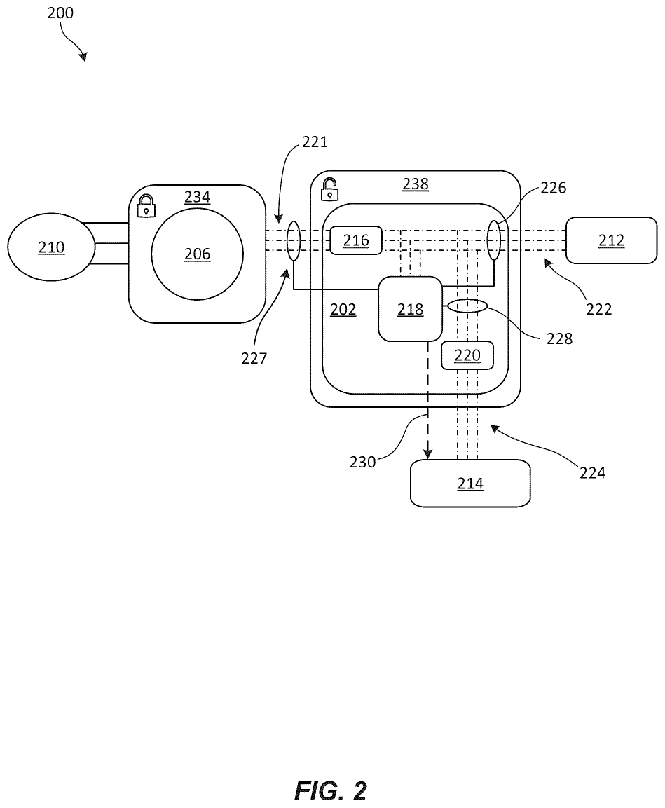

FIG. 2 is a schematic view of a power supply system 200 that includes an electrical power control device 202, according to at least one additional embodiment of the present disclosure.

In some respects, the power supply system 200 of FIG. 2 may be similar to the power supply system 100 illustrated in FIG. 1. For example, the power supply system 200 of FIG. 2 may include a power meter 206 that receives electrical power from a utility grid 210. The power supply system 200 may also include the electrical power control device 202 that may be configured to monitor electrical characteristics of an input power connection 221, a main power connection 222 to a disconnect panel 212 and of an auxiliary power connection 224 to an auxiliary device 214, such as via a respective input sensor 227, a main sensor 226, and/or an auxiliary sensor 228. The electrical power control device 202 may include an input disconnect 216 coupled to the input power connection 221, an auxiliary control module 218, and an auxiliary disconnect 220 coupled to the auxiliary power connection 224. The electrical power control device 202 may also include a control server configured to send instructions 230 to the auxiliary device 214 to control power consumption, such as to reduce the power consumption when a total current reaches or exceeds a predetermined threshold.

Referring to FIG. 2, the power supply system 200 may include a meter socket 234 containing the power meter 206 that is physically separate from a housing 238 that contains the electrical power control device 202. In some examples, the housing 238 and electrical power control device 202 therein may be mounted adjacent to (e.g., along a same wall as) the meter socket 234. In additional examples, the housing 238 and electrical power control device 202 may be mounted remotely from the meter socket 234, such as adjacent to the auxiliary device 214 or adjacent to the disconnect panel 212.

Accordingly, referring to FIGS. 1 and 2, electrical power control devices 102, 202 of the present disclosure may be implemented as part of an expanded meter socket 101 or via a housing 238 that is separate from a meter socket 234. The functional components of the electrical power control devices 102, 202 may be the same or similar in either case.

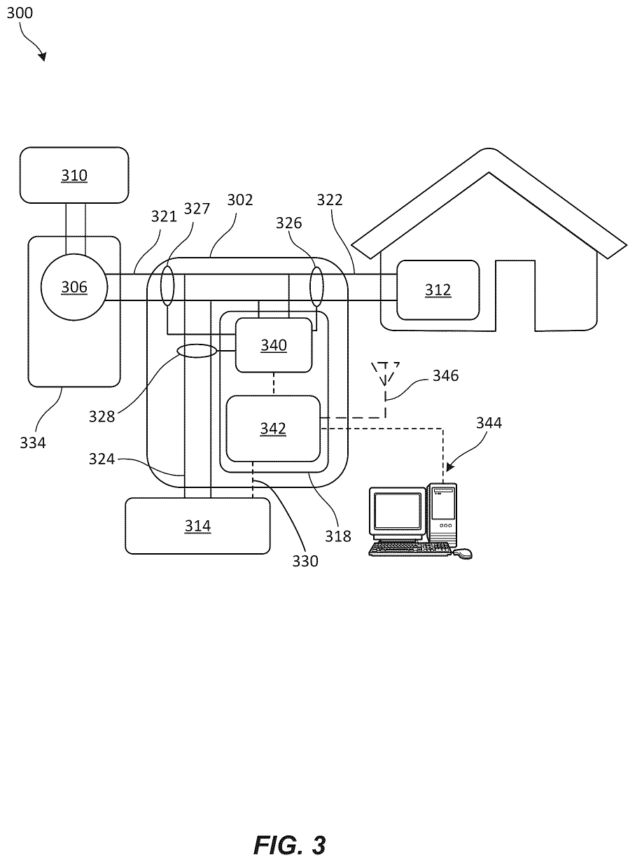

FIG. 3 is a schematic diagram of a power supply system 300 that includes an electrical power control device 302, according to at least one further embodiment of the present disclosure.

In some respects, the power supply system 300 of FIG. 3 may be similar to the power supply system 100 of FIG. 1 and/or to the power supply system 200 of FIG. 2. For example, the power supply system 300 may include a power meter 306 that receives electrical power from a utility grid 310, a disconnect panel 312, and an auxiliary device 314 (e.g., an EV charging station, an EV, a pump, an air conditioning unit, a heater, a refrigerator, etc.). The power supply system 300 may also include the electrical power control device 302, which may be configured to monitor electrical characteristics (e.g., voltage, current, etc.) of an input power connection 321 from the power meter 306, a main power connection 322 to the disconnect panel 312, and an auxiliary power connection 324 to the auxiliary device 314. The electrical power control device 302 may include an auxiliary control module 318.

The electrical power control device 302 may be housed in an expanded meter socket, such as the expanded meter socket 101 (FIG. 1), or the electrical power control device 302 may be housed in a housing separate from a meter socket, such as the housing 238 of FIG. 2.

Referring to FIG. 3, the auxiliary control module 318 may include a data collection module 340 and a communication module 342. The data collection module 340 may be configured to receive data representative of a total electrical characteristic (e.g., current, voltage) of the input power connection 321 from an input sensor 327 coupled to the input power connection 321. The data collection module 340 may also be configured to receive data representative of at least one first electrical characteristic (e.g., current, voltage) of the main power connection 322 from at least one main sensor 326 coupled to the main power connection 322. The data collection module 340 may also be configured to receive data representative of at least one second electrical characteristic (e.g., current, voltage) of the auxiliary power connection 324 from at least one auxiliary sensor 328 coupled to the auxiliary power connection 324. In some examples, the data collection module 340 may include an analog-to-digital converter to convert analog data from the input sensor 327, main sensor 326, and/or auxiliary sensor 328 to digital data.

The communication module 342 may be configured to receive information based on the at least one first electrical characteristic and the at least one second electrical characteristic from the data collection module 340. The communication module 342 may also be configured to communicate that information to a user device 344 or other recipient. By way of example and not limitation, the user device 344 or other recipient may be a personal computer, a mobile device (e.g., a mobile phone, a tablet, etc.), a laptop computer, a data storage device, a smart television, a smart speaker, a server, a network (e.g., a cellular network, the internet, a local area network (LAN), etc.), an external local controller, etc. The user device 344 may be a device controlled by a consumer of the energy (e.g., a homeowner or a business owner), or a device controlled by a provider of the energy (e.g., a utility service provider).

The communication module 342 may communicate the information to the user device 344 via a wired connection, a wireless connection, or a combination thereof. In the case of a wireless connection, in some examples the electrical power control device 302 may include an antenna 346. In some embodiments, the antenna 346 may physically extend outside of a housing containing the auxiliary control module 318, such as to avoid or inhibit signal shielding that may otherwise be caused by the housing.

The communication module 342 may also include a control server, which may send instructions 330 to the auxiliary device 314 to control power usage in one or more situations. For example, the instructions 330 may be sent when a total current sensed by the input sensor 327 and/or by the at least one main sensor 326 and the at least one auxiliary sensor 328 reaches or exceeds a predetermined threshold. In additional examples, the instructions 330 may be sent when user preferences are met (e.g., time-of-day restrictions, maximum current draw restrictions, etc.). In further examples, the instructions 330 may be sent based on local electricity generation data.

Although illustrated as separate elements, in some examples the data collection module 340 and the communication module 342 may represent portions of a single module or application. In addition, in certain embodiments one or more of these modules may represent one or more software applications or programs that, when executed by one or more computing devices, may cause the computing device(s) to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

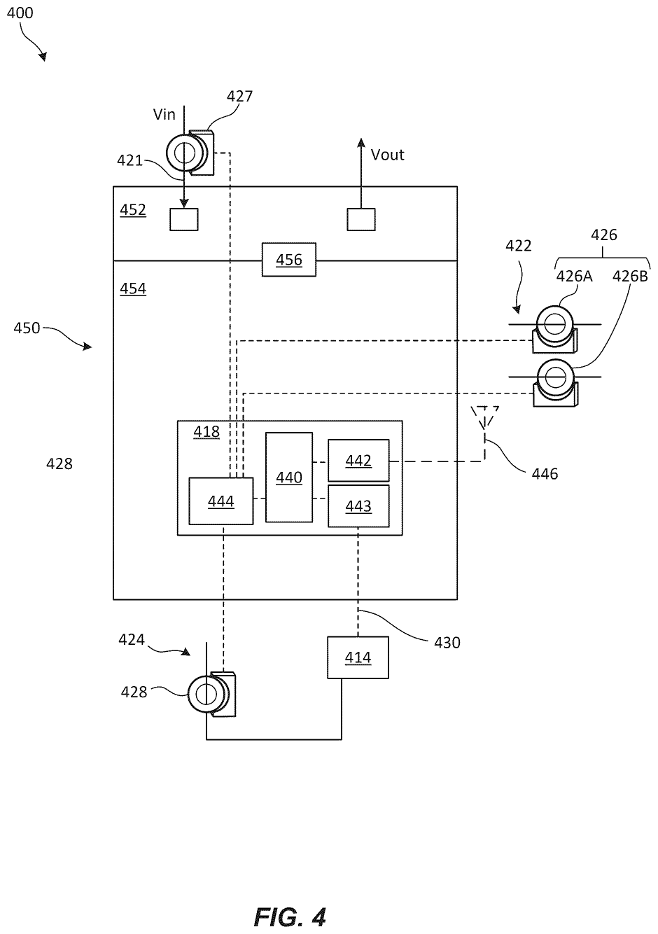

FIG. 4 is a schematic diagram of an electrical power control device 400, according to at least one embodiment of the present disclosure. In some examples, the electrical power control device 400 may be implemented or employed as any of the electrical power control devices 102, 202, 302 described above.

The electrical power control device 400 may include an auxiliary control module 418, which may be implemented in one or more microcontrollers and/or separate modules. The auxiliary control module 418 may include a data collection module 440, a communication module 442, and a control server 443.

The data collection module 440 may receive data from an input sensor 427 coupled to an input connection 421. Additionally or alternatively, the data collection module 440 may receive data from at least one main sensor 426 (e.g., a first main sensor 426A and a second main sensor 426B) coupled to a main power connection 422. In the example illustrated in FIG. 4, the main power connection 422 may be configured for split-phase power. The first main sensor 426A may be coupled to a hot wire associated with a first AC phase and the second main sensor 426B may be coupled to a hot wire associated with a second AC phase. In additional embodiments, a single main sensor 426 or more than two main sensors 426 may be employed. The first main sensor 426A and the second main sensor 426B may be configured to sense one or more electrical characteristics (e.g., current, voltage) of the main power connection 422.

The data collection module 440 may also receive data from at least one auxiliary sensor 428. Only one auxiliary sensor 428 is illustrated in FIG. 4. However, the present disclosure is not so limited. In additional embodiments, multiple auxiliary sensors 428 may be used. The at least one auxiliary sensor 428 may be coupled to an auxiliary power connection 424, such as a hot wire of the auxiliary power connection 424, connected to an auxiliary device 414. The at least one auxiliary sensor 428 may be configured to sense at least one electrical characteristic (e.g., current, voltage) of the auxiliary power connection 424.

The auxiliary control module 418 may also include an analog-to-digital converter 444 for converting analog signals from the input sensor 427, at least one main sensor 426, and at least one auxiliary sensor 428 to digital signals. The data collection module 440 may receive the digital signals from the analog-to-digital converter 444 and may pass information based on the digital signals to the communication module 442 for communication to a user device, such as via a wired connection or a wireless connection (e.g., via an antenna 446). The data collection module 440 may also pass information based on the digital signals to the control server 443, which may send instructions 430 to the auxiliary device 414 to control power usage of the auxiliary device 414 based on the information.

For example, the control server 443 may compare a total current in the main power connection 422 and in the auxiliary power connection 424 to a predetermined threshold to determine whether to instruct the auxiliary device 414 to increase or decrease its power usage. In cases where a first main sensor 426A and a second main sensor 426B are used as illustrated in FIG. 4 and as explained above, an electrical current imbalance may exist in the two hot lines of the main power connection 422. In this case, the control server 443 may take a highest reading from the first and second main sensors 426A, 426B in calculating the total current.

In some examples, the predetermined threshold may be expressed as a percentage of a maximum ampacity rating of an electrical power supply system, such as between 50% and 95% of the maximum ampacity rating. In some examples, the predetermined threshold may be between 65% and 90% of the maximum ampacity rating, such as 70%, 80%, 85%, or 90% of the maximum ampacity rating. In additional examples, the predetermined threshold may be expressed as an electrical current value in amperes. In yet further examples, the predetermined threshold may be expressed as an electrical power value in watts or kilowatts. In some embodiments, the predetermined threshold may be variable, such as in response to user settings or external controls that dictate one predetermined threshold at one time of day and another predetermined threshold at another time of day. The predetermined threshold may also be variable in cases where a local electricity generator is used, with a higher predetermined threshold during times of high local electricity generation and a lower predetermined threshold during times of low local electricity generation.

In some examples of the present disclosure, the electrical power control device 400 may include one or more printed circuit boards (PCBs). For example, as illustrated in FIG. 4, a main PCB 450 may support the auxiliary control module 418. The main PCB 450 may include a high-voltage power plane 452 (e.g., a 240 VAC power plane) and a low-voltage power plane 454 (e.g., a 5 V power plane, a 3.3 V power plane, etc.). The main PCB 450 may also include a ground plane. The high-voltage power plane 452 may be operably coupled to the low-voltage power plane 454 by a step-down transformer 456, which may convert high voltage from the high-voltage power plane 452 to low voltage to supply the low-voltage power plane 454.

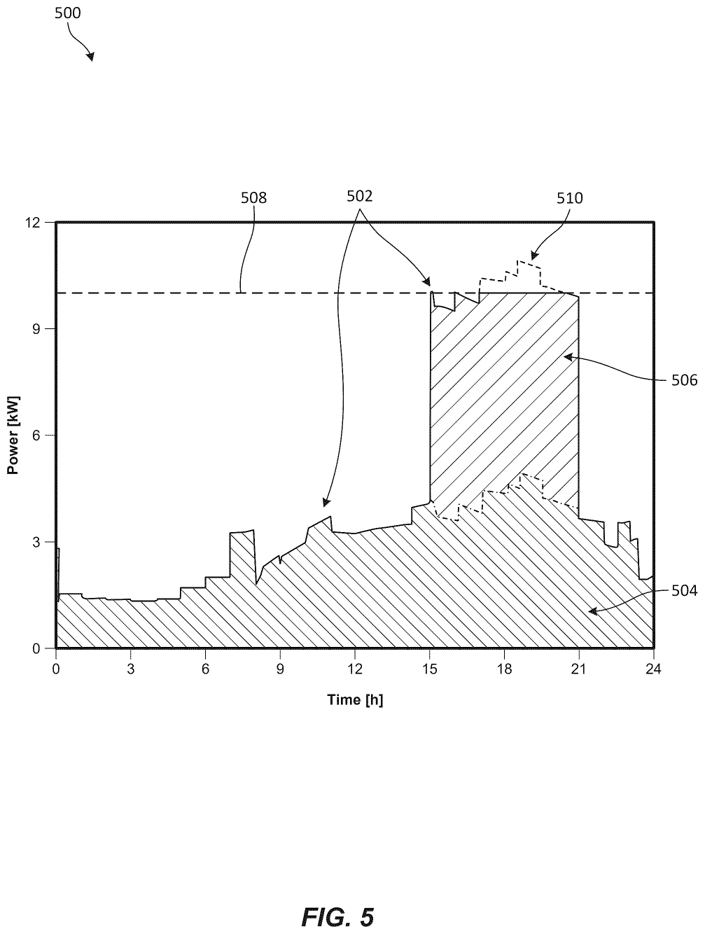

FIG. 5 is a plot 500 illustrating an example of power usage of a power supply system over the course of a day, according to at least one embodiment of the present disclosure. By way of example, the power supply system may be any of the power supply systems 100, 200, 300 described above.

The plot 500 will be explained in the context of a residence for illustration purposes. However, power usage may be controlled by systems and devices of the present disclosure in similar ways in other contexts, as well.

A total power 502 (solid plot line) used by the power supply system may vary over the course of the day based on electricity demand from various appliances, lighting, heating and cooling systems, auxiliary devices, etc. For example, the lower part of the plot 500 includes main power consumed 504 through a main power connection to a disconnect panel, such as a residential breaker panel. The upper part of the plot 500 includes auxiliary power consumed 506 through an auxiliary power connection to an auxiliary device, such as an EV charging station or an EV.

In the example shown in FIG. 5, during early morning hours there may be little main power consumed 504, such as while as residents sleep. During late morning, daytime, afternoon, and early evening hours, the main power consumed 504 generally rises, such as while the residents awaken and use more electricity. During late night hours, the main power consumed 504 generally drops, such as while residents sleep.

In the late afternoon and evening, an electric vehicle may be charged by an EV charging station, represented by the auxiliary power consumed 506. This may be a time of high power usage from both the main residence and the auxiliary device. In this example, without power control of the auxiliary device according to the present disclosure, the total power usage would increase over a predetermined threshold 508 of 10 kW, as represented by dashed plot lines 510. However, an electrical power control device according to the present disclosure, such as any of the electrical power control devices 102, 202, 302, 400, may be employed to limit the total power 502 to the predetermined threshold 508. The value of 10 kW of the predetermined threshold 508 is provided as an example. Systems and devices according to the present disclosure may use other values for the predetermined threshold 508.

For example, the electrical power control device may sense that the total power 502 reaches or exceeds the predetermined threshold 508. In response, the electrical power control device may send instructions to the EV charging device to reduce the auxiliary power consumption 506 to a level that the total power 502 from the EV charging device and the main residence is at or below the predetermined threshold, even while the main power consumption 504 is high and variable.

Since the predetermined threshold 508 may be less than a maximum ampacity rating of the power supply system, systems and devices of the present disclosure may reduce a likelihood that a disconnect (e.g., breaker, fuse, etc.) may trip during times of high power demand. Likewise, the auxiliary device may continue to operate at as high a power as possible while the power supply system as a whole is operated at or below the predetermined threshold 508.

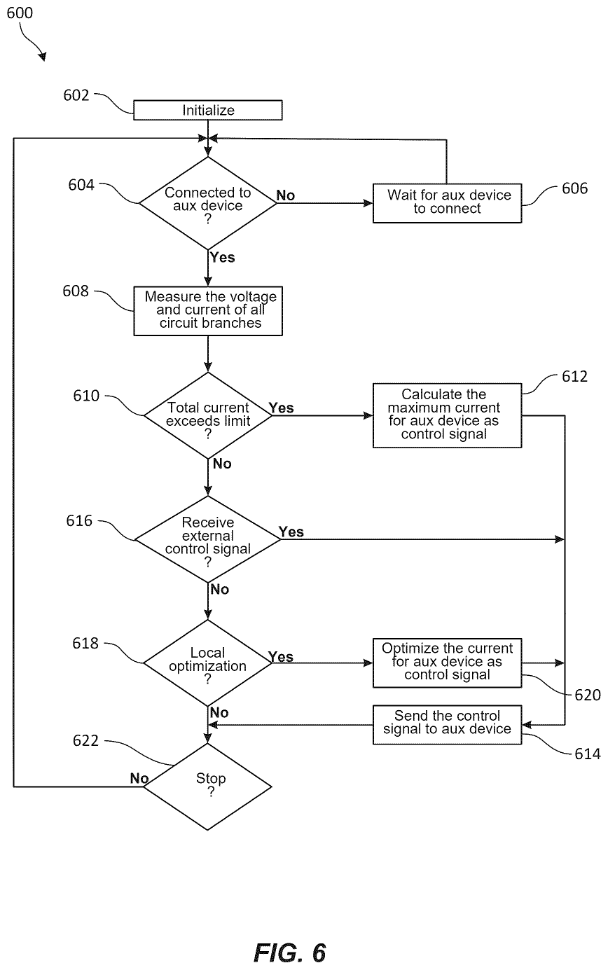

FIG. 6 is a flow diagram illustrating a method 600 of operating an electrical power control device (e.g., any of the electrical power control devices 102, 202, 302, 400 described above), according to at least one embodiment of the present disclosure.

Operation 602 is an initialization step. At operation 602, basic settings of the electrical power control device may be set up. For example, a user or technician may set a predetermined threshold below which a power supply system may be allowed to operate. Parameters of an auxiliary device may be input. Times of high current draw and/or low current draw may be set.

At operation 604, a connection to an auxiliary device may be established. In examples where the auxiliary device is an EV charger or an EV that employs an OCPP communication standard, an OCPP communication link may be made between the auxiliary device and the electrical power control device. If no auxiliary device is connected, the electrical power control device may wait and attempt to detect an auxiliary device at operation 606.

If a connection to an auxiliary device is established at operation 604, then the electrical power control device may measure the voltage and/or current of all circuit branches at operation 608, including a main electrical connection to a disconnect panel and an auxiliary electrical connection to the auxiliary device. For example, one or more main sensors and one or more auxiliary sensors may provide data to the electrical power control device, which data may be indicative of voltage and/or current values. The total electricity usage (e.g., total current, total voltage, total power) may be calculated by adding the measured values of all the circuit branches.

At operation 610, the electrical power control device may determine whether the total current reaches or exceeds the predetermined threshold. If the total current has reached or exceeded the predetermined threshold, at operation 612 the electrical power control device may calculate the maximum current at which the auxiliary device may operate to keep the total current at or below the predetermined threshold. This maximum current may be part of a control signal to be sent to the auxiliary device at operation 614, to instruct the auxiliary device to operate at or below the maximum current.

If the total current does not meet or exceed the limit as determined at operation 610, the electrical power control device may check whether an external control signal has been received at operation 616. The external control signal may be a signal from an external device or system, such as an upper energy management system, to control the power consumption of the auxiliary device. If an external control signal has been received, then the external control signal may be communicated to the auxiliary device at operation 614.

If an external control signal has not been received, then the electrical power control device may determine whether local optimization parameters are met at operation 618. For example, the local optimization parameters may result from active programming, such as due to a service area where time-of-day rate increases are enforced. For example, a user may input the time-of-day restriction times and/or rate increases, a maximum cost range, or the like and the electrical power control device may be used to enforce limits on the auxiliary device power consumption accordingly. If local optimization parameters are met, the electrical power control device may determine the corresponding current usage of the auxiliary device at operation 620, and may send the corresponding current usage to the auxiliary device as a control signal at operation 614.

At operation 622, the electrical power control device may determine whether the method 600 should be stopped, such as due to the auxiliary device not being in use or being disconnected, due to a user command to stop, during maintenance of the power supply system, during a reprogramming of the electrical power control device, etc. If the method 600 should not be stopped, then the method 600 may be repeated by ensuring a connection to the auxiliary device is established at operation 604, and so forth.

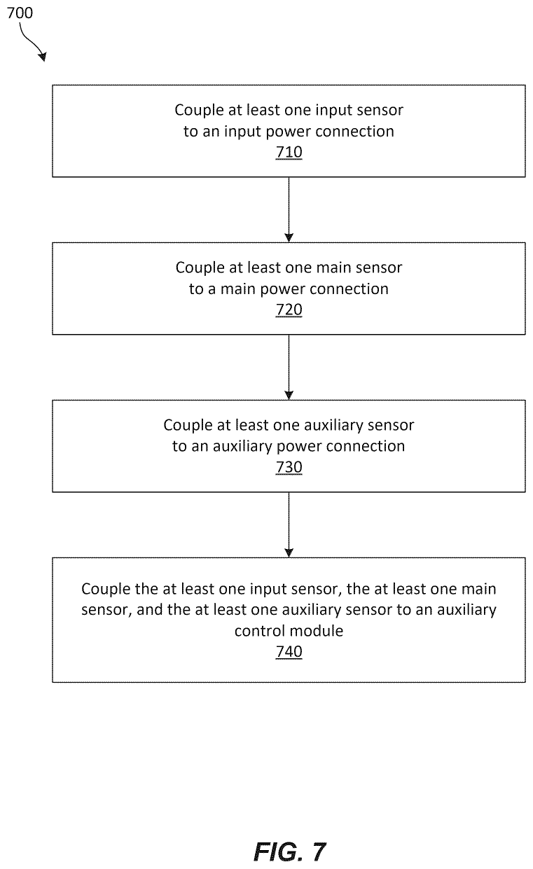

FIG. 7 is a flow diagram illustrating a method 700 of forming an electrical power control device, according to at least one embodiment of the present disclosure.

At operation 710, at least one input sensor (e.g., an input current sensor) may be coupled to an input power connection that is configured to provide power to both the main power connection and the auxiliary power connection.

At operation 720, at least one main sensor (e.g., a main current sensor) may be coupled to a main power connection to sense at least one first electrical characteristic of the main power connection and to generate main sensor data.

At operation 730, at least one auxiliary sensor (e.g., an auxiliary current sensor) may be coupled to an auxiliary power connection to sense at least one second electrical characteristic of the auxiliary power connection and to generate auxiliary sensor data.

At operation 740, the at least one input sensor, the at least one main sensor, and the at least one auxiliary sensor may be coupled to an auxiliary control module configured to send a control instruction to an auxiliary device, such that the input sensor data, the main sensor data, and the auxiliary sensor data can be provided to the auxiliary control module.

Accordingly, the present disclosure includes electrical power control devices and related methods that may be improved in some respects over existing solutions. For example, some embodiments of the present disclosure may be able to control power usage of auxiliary devices to maintain total power usage under a predetermined threshold.

The following example embodiments are also included in the present disclosure.

Example 1. An electrical power control device, including: a main power connection for transmitting electrical power to a disconnect panel; an auxiliary power connection for transmitting electrical power to an auxiliary device; and an auxiliary control module, including: at least one sensor for sensing a total current flowing through the main power connection and the auxiliary power connection; and a control server configured to send instructions to the auxiliary device to control power usage based on a comparison of the total current to a predetermined threshold.

Example 2. The device of Example 1, further including a communication module for communicating information based on the total current to a user device.

Example 3. The device of Example 2, wherein the communication module includes an antenna for wirelessly communicating the information to the user device.

Example 4. The device of Example 2, wherein the communication module includes a wired connection for communicating the information to the user device.

Example 5. The device of any one of Examples 1 through 4, wherein the at least one sensor includes at least one of: an input sensor for sensing an electrical current in an input power connection leading to the main power connection and the auxiliary power connection; or a main current sensor for sensing an electrical current in the main power connection and an auxiliary current sensor for sensing an electrical current in the auxiliary power connection.

Example 6. The device of any one of Examples 1 through 5, wherein the auxiliary device includes at least one of: an electric vehicle charging station, or an electric vehicle.

Example 7. The device of Example 6, wherein the control server is configured to send instructions to the electric vehicle charging station or the electric vehicle using an Open Charge Point Protocol (OCPP) communication standard.

Example 8. The device of any one of Examples 1 through 7, wherein the control server is further configured to send instructions to the auxiliary device to control power usage based on user preferences.

Example 9. The device of Example 8, wherein the user preferences include at least one of: a user-defined maximum current limit; or user-defined preferred time-of-day charging indications.

Example 10. The device of any one of Examples 1 through 9, wherein the control server is further configured to send instructions to the auxiliary device to control power usage based on local electricity generation data.

Example 11. The device of Example 10, wherein the predetermined threshold increases when local electricity generation increases.

Example 12. The device of any one of Examples 1 through 11, wherein the control server is further configured to send instructions to the auxiliary device to control power usage in response to an external control signal communicated to the control server.

Example 13. The device of any one of Examples 1 through 12, further including an auxiliary disconnect along the auxiliary power connection.

Example 14. The device of any one of Examples 1 through 13, wherein the disconnect panel includes a breaker panel.

Example 15. An electrical power control device, including: a main power connection for transmitting electrical power to a disconnect panel; an auxiliary power connection for transmitting electrical power to at least one of: an electric vehicle (EV) charging station or an EV; and an auxiliary control module, including: at least one sensor for sensing a total current flowing through the main power connection and through the auxiliary power connection; and a control server configured to send instructions to the EV charging station or EV to control power usage of the EV charging station or EV based on a comparison of a total current to a predetermined threshold.

Example 16. The device of Example 15, wherein the control server is configured to send instructions to the EV charging station or EV using an Open Charge Point Protocol (OCPP) communication standard.

Example 17. The device of Example 15 or Example 16, wherein the main power connection and the auxiliary power connection receive electrical power from a power meter.

Example 18. The device of any one of Examples 15 through 17, wherein the control server is configured to send instructions to the EV charging station or EV to reduce power usage when the total current reaches or exceeds the predetermined threshold and to increase power usage when the total current drops below the predetermined threshold.

Example 19. A method of forming an electrical power control device, the method including: coupling at least one main sensor to a main power connection to sense at least one first electrical characteristic of the main power connection and to generate main sensor data; coupling at least one auxiliary sensor to an auxiliary power connection to sense at least one second electrical characteristic of the auxiliary power connection and to generate auxiliary sensor data; and coupling the at least one main sensor and the at least one auxiliary sensor to an auxiliary control module configured to send a control instruction to an auxiliary device, such that the main sensor data and the auxiliary sensor data can be provided to the auxiliary control module.

Example 20. The method of Example 19, wherein: coupling the at least one main sensor to the main power connection includes coupling a main current sensor to the main power connection; and coupling the at least one auxiliary sensor to the auxiliary power connection includes coupling an auxiliary current sensor to the auxiliary power connection.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An electrical power control device, comprising:
a main power connection for transmitting electrical power to a disconnect panel;
an auxiliary power connection for transmitting electrical power to an auxiliary device; and
an auxiliary control module, comprising:
at least one sensor for sensing a total current flowing through the main power connection and the auxiliary power connection; and
a control server configured to send instructions to the auxiliary device to control power usage based on a comparison of the total current to a predetermined threshold.

2. The device of claim 1, further comprising a communication module for communicating information based on the total current to a user device.

3. The device of claim 2, wherein the communication module comprises an antenna for wirelessly communicating the information to the user device.

4. The device of claim 2, wherein the communication module comprises a wired connection for communicating the information to the user device.

5. The device of claim 1, wherein the at least one sensor comprises at least one of:
an input sensor for sensing an electrical current in an input power connection leading to the main power connection and the auxiliary power connection; or
a main current sensor for sensing an electrical current in the main power connection and an auxiliary current sensor for sensing an electrical current in the auxiliary power connection.

6. The device of claim 1, wherein the auxiliary device comprises at least one of: an electric vehicle charging station, or an electric vehicle.

7. The device of claim 6, wherein the control server is configured to send instructions to the electric vehicle charging station or the electric vehicle using an Open Charge Point Protocol (OCPP) communication standard.

8. The device of claim 1, wherein the control server is further configured to send instructions to the auxiliary device to control power usage based on user preferences.

9. The device of claim 8, wherein the user preferences include at least one of:
a user-defined maximum current limit; or
user-defined preferred time-of-day charging indications.

10. The device of claim 1, wherein the control server is further configured to send instructions to the auxiliary device to control power usage based on local electricity generation data.

11. The device of claim 10, wherein the predetermined threshold increases when local electricity generation increases.

12. The device of claim 1, wherein the control server is further configured to send instructions to the auxiliary device to control power usage in response to an external control signal communicated to the control server.

13. The device of claim 1, further comprising an auxiliary disconnect along the auxiliary power connection.

14. The device of claim 1, wherein the disconnect panel comprises a breaker panel.

15. An electrical power control device, comprising:
a main power connection for transmitting electrical power to a disconnect panel;
an auxiliary power connection for transmitting electrical power to at least one of: an electric vehicle (EV) charging station or an EV; and
an auxiliary control module, comprising:
at least one sensor for sensing a total current flowing through the main power connection and through the auxiliary power connection; and
a control server configured to send instructions to the EV charging station or EV to control power usage of the EV charging station or EV based on a comparison of a total current to a predetermined threshold.

16. The device of claim 15, wherein the control server is configured to send instructions to the EV charging station or EV using an Open Charge Point Protocol (OCPP) communication standard.

17. The device of claim 15, wherein the main power connection and the auxiliary power connection receive electrical power from a power meter.

18. The device of claim 15, wherein the control server is configured to send instructions to the EV charging station or EV to reduce power usage when the total current reaches or exceeds the predetermined threshold and to increase power usage when the total current drops below the predetermined threshold.

19. A method of forming an electrical power control device, the method comprising:
coupling at least one input sensor to an input power connection to sense a total electrical characteristic of the input power connection and to generate input sensor data;
coupling at least one main sensor to a main power connection to sense at least one first electrical characteristic of the main power connection and to generate main sensor data;
coupling at least one auxiliary sensor to an auxiliary power connection to sense at least one second electrical characteristic of the auxiliary power connection and to generate auxiliary sensor data; and
coupling the at least one input sensor, the at least one main sensor, and the at least one auxiliary sensor to an auxiliary control module configured to send a control instruction to an auxiliary device, such that the input sensor data, main sensor data and the auxiliary sensor data can be provided to the auxiliary control module.

20. The method of claim 19, wherein:
coupling the at least one input sensor to an input power connection comprises coupling an input current sensor to the input power connection;
coupling the at least one main sensor to the main power connection comprises coupling a main current sensor to the main power connection; and
coupling the at least one auxiliary sensor to the auxiliary power connection comprises coupling an auxiliary current sensor to the auxiliary power connection.
